(19) United States
(12) Patent Application Publication
(10) Pub. No.: US 2024/0325909 A1
(43) Pub. Date: Oct. 3, 2024

(54) GAME CONTROLLING METHOD AND APPARATUS, COMPUTER DEVICE AND STORAGE MEDIUM

(71) Applicant: Beijing Zitiao Network Technology Co., Ltd., Beijing (CN)

(72) Inventors: Yupei JIANG, Beijing (CN); Hongting YAO, Beijing (CN)

(21) Appl. No.: 18/545,759

(22) Filed: Dec. 19, 2023

Related U.S. Application Data
(63) Continuation of application No. PCT/CN2022/126139, filed on Oct. 19, 2022.

(30) Foreign Application Priority Data
Dec. 7, 2021 (CN) 202111489276.7

(51) Int. Cl. A63F 13/56; A63F 13/52; A63F 13/58

(52) U.S. Cl. CPC A63F 13/56; A63F 13/52; A63F 13/58

(57) ABSTRACT

The present disclosure provides a game control method, the method comprises: in response to a battleground establishment event being triggered, establishing a game battleground, the game battleground comprising at least one game camp; in response to an interaction request of interacting with a first target virtual object in the plurality of virtual objects, determining a belonging target battleground according to a game camp of a requester, and determining whether an interaction condition is met according to virtual object occupation information of each game camp in the belonging target battleground and the connection relationship among the virtual objects; in response to the interaction condition being met, sending an interaction request success response, the interaction request success response being used for indicating that an interaction operation on the first target virtual object is permitted.

### CROSS-REFERENCE TO RELATED APPLICATION(S)

This application is a national stage application filed under 35 U.S.C. 371 based on International Patent Application No. PCT/CN2022/126139, filed on Oct. 19, 2022, which claims priority to Chinese Application No. 202111489276.7 entitled “Game controlling method and apparatus, computer device and storage medium” filed with the Chinese Patent office on Dec. 7, 2021. The full disclosures of these applications are incorporated in the present application by reference.

### FIELD

The present disclosure relates to the technical field of gaming, and in particular, to a game controlling method and apparatus, a computer device, a storage medium, a computer program product and program.

### BACKGROUND

Currently, in games where a plurality of players are simultaneously online to occupy territories or cities, players focus on the territory or city seizure gameplay. The game process is mainly that a plurality of players form a guild and the strength of the players in the group determines the results of the guild to take over the city and benefits. Such a gameplay style is rather monotonous.

### SUMMARY

The embodiments of the present disclosure at least provide a game controlling method, apparatus, computer device, storage medium, computer program product and program.

In a first aspect, an embodiment of the present disclosure provides a game controlling method, a scene of a game comprises a plurality of game camps, a plurality of virtual objects and a connection relationship among the virtual objects, and the method comprises: in response to a battleground establishment event being triggered, establishing a game battleground, the game battleground comprising at least one game camp; in response to an interaction request of interacting with a first target virtual object in the plurality of virtual objects, determining a belonging target battleground according to a game camp of a requester, and determining whether an interaction condition is met according to virtual object occupation information of each game camp in the belonging target battleground and the connection relationship among the virtual objects; and in response to the interaction condition being met, sending an interaction request success response; the interaction request success response being used for indicating that an interaction operation on the first target virtual object is permitted.

In an optional implementation, in response to a battleground establishment event being triggered, establishing the game battleground comprises: in response to a second target virtual object in the plurality of virtual objects being occupied for a first time by a first game camp that does not belong to any game battleground, establishing the game battleground; wherein the game battleground comprises the first game camp.

In an optional implementation, the method further comprises: in response to a battleground joining event corresponding to joining the game battleground being triggered, controlling a second game camp that triggers the battleground joining event to join the game battleground.

In an optional implementation, in response to the battleground joining event corresponding to joining the game battleground being triggered, controlling the second game camp that triggers the battleground joining event to join the game battleground comprises: in response to the battleground joining event corresponding to joining the game battleground being triggered, determining whether a number of game camps included in the game battleground reaches a preset number threshold and determining whether the first game camp agrees with the second game camp to join the game battleground; and in response to the number of the game camps included in the game battleground not reaching the preset number threshold and the first game camp agreeing with the second game camp to join the game battleground, controlling the second game camp to join the game battleground.

In an optional implementation, in response to the interaction request of interacting with the first target virtual object in the plurality of virtual objects, determining the belonging target battleground according to the game camp of the requester, and determining whether the interaction condition is met according to the virtual object occupation information of each game camp in the belonging target battleground and the connection relationship among the virtual objects comprises: in response to the interaction request of interacting with the first target virtual object in the plurality of virtual objects, determining the belonging target battleground according to the game camp of the requester; in response to the target battleground being successfully determined, determining whether the interaction condition is met according to the virtual object occupation information of each game camp in the target battleground and the connection relationship among the virtual objects; and in response to the target battleground failing to be determined, determining whether the interaction condition is met according to the virtual object occupation information of the game camp corresponding to the interaction request and the connection relationship among the virtual objects.

In an optional implementation, in response to the target battleground being successfully determined, determining whether the interaction condition is met according to the virtual object occupation information of each game camp in the target battleground and the connection relationship among the virtual objects comprises: determining whether the first target virtual object has a direct connection relationship with a virtual object occupied by a game camp in the target battleground according to the virtual object occupation information of each game camp in the target battleground and the connection relationship among the virtual objects; and in response to YES, determining that the interaction condition is met.

In an optional implementation, the plurality of virtual objects comprise: a first virtual object located in a first area, and a second virtual object located in a second area;
determining whether the first target virtual object has the direct connection relationship with the virtual object occupied by the game camp in the target battleground according to the virtual object occupation information of each game camp in the target battleground and the connection relationship among the virtual objects comprises:
determining whether the first target virtual object is located in the first area;
in response to the first target virtual object being located in the first area, determining whether the first target virtual object has the direct connection relationship with the virtual object occupied by the game camp in the target battleground according to the virtual object occupation information of each game camp in the target battleground and the connection relationship among the virtual objects.

In an optional implementation, there is further comprised: in response to a resource allocation event being triggered, determining resource allocation information of each game camp in the game battleground based on the virtual object occupation information of each game camp in the game battleground; and allocating game resources based on the resource allocation information.

In an optional implementation, the game resources comprise: camp resources allocated to each game camp in the game battleground, and/or, game character resources allocated to game characters in each game camp in the game battleground.

In an optional implementation, the resource allocation event comprises at least one of: the current time reaching preset resource settlement time; and a third target virtual object in the virtual objects being occupied by any game camp.

In a second aspect, an embodiment of the present disclosure provides a game controlling method, a scene of a game comprises a plurality of game camps, a plurality of virtual objects and a connection relationship among the virtual objects, each game camp comprises a plurality of virtual characters, and the method comprises: in response to an interaction request of a target virtual character interacting with a first target virtual object in the plurality of virtual objects being triggered, sending the interaction request to a server; and in response to an interaction request success response fed back by the server based on the interaction request, enabling an interaction permission of the target virtual character interacting with the first target virtual object; wherein the interaction request success response is determined by the server according to virtual object occupation information of each game camp in a target battleground to which a game camp of the target virtual character belongs, and the connection relationship among the virtual objects.

In an optional implementation, the interaction request is an attack request of attacking the first target virtual object, and the method further comprises: in response to the attack request succeeding, controlling the target virtual character to enter an attack scene of attacking the first target virtual object.

In an optional implementation, the method further comprises: obtaining a game resource allocated by the server to the target virtual character; wherein the game resource is determined by the server based on the virtual object occupation information corresponding to each game camp in the target battleground after a resource allocation event is triggered.

In a third aspect, an embodiment of the present disclosure further provides a game controlling apparatus, a scene of the game comprising a plurality of game camps, a plurality of virtual objects and connection relationships among the virtual objects, the apparatus comprising:
a generating module, configured to in response to a battleground establishment event being triggered, establish a game battleground, the game battleground comprising at least one game camp;
a first processing module, configured to in response to an interaction request of interacting with a first target virtual object in the plurality of virtual objects, determine a belonging target battleground according to a game camp of a requester, and determine whether an interaction condition is met according to virtual object occupation information of each game camp in the belonging target battleground and the connection relationship among the virtual objects; in response to the interaction condition being met, send an interaction request success response, the interaction request success response being used for indicating that the interaction operation on the first target virtual object is permitted.

In an optional implementation, when, in response to a battleground establishment event being triggered, establish the game battleground, the generating module is configured to in response to a second target virtual object in the plurality of virtual objects being occupied for a first time by a first game camp that does not belong to any game battleground, establishing the game battleground; wherein the game battleground comprises the first game camp.

In an optional implementation, the first processing module is configured to in response to a battleground joining event corresponding to joining the game battleground being triggered, control a second game camp that triggers the battleground joining event to join the game battleground.

In an optional implementation, when, in response to the battleground joining event corresponding to joining the game battleground being triggered, control the second game camp that triggers the battleground joining event to join the game battleground, the first processing module is configured to, in response to the battleground joining event corresponding to joining the game battleground being triggered, determine whether a number of game camps included in the game battleground reaches a preset number threshold and determine whether the first game camp agrees with the second game camp to join the game battleground; and in response to the number of the game camps included in the game battleground not reaching the preset number threshold and the first game camp agreeing with the second game camp to join the game battleground, control the second game camp to join the game battleground.

In an optional implementation, when, in response to the interaction request of interacting with the first target virtual object in the plurality of virtual objects, determining the belonging target battleground according to the game camp of the requester, and determining whether the interaction condition is met according to the virtual object occupation information of each game camp in the belonging target battleground and the connection relationship among the virtual objects, the first processing module is configured to, in response to the interaction request of interacting with the first target virtual object in the plurality of virtual objects, determining the belonging target battleground according to the game camp of the requester; in response to the target battleground being successfully determined, determining whether the interaction condition is met according to the virtual object occupation information of each game camp in the target battleground and the connection relationship among the virtual objects; and in response to the target battleground failing to be determined, determining whether the interaction condition is met according to the virtual object occupation information of the game camp corresponding to the interaction request and the connection relationship among the virtual objects.

In an optional implementation, when, in response to the target battleground being successfully determined, determining whether the interaction condition is met according to the virtual object occupation information of each game camp in the target battleground and the connection relationship among the virtual objects, the first processing module is configured to determining whether the first target virtual object has a direct connection relationship with a virtual object occupied by a game camp in the target battleground according to the virtual object occupation information of each game camp in the target battleground and the connection relationship among the virtual objects; and in response to YES, determining that the interaction condition is met.

In an optional implementation, the plurality of virtual objects comprise: a first virtual object located in a first area, and a second virtual object located in a second area; when determine whether the first target virtual object has the direct connection relationship with the virtual object occupied by the game camp in the target battleground according to the virtual object occupation information of each game camp in the target battleground and the connection relationship among the virtual objects, the first processing module is configured to determine whether the first target virtual object is located in the first area; and in response to the first target virtual object being located in the first area, determine whether the first target virtual object has the direct connection relationship with the virtual object occupied by the game camp in the target battleground according to the virtual object occupation information of each game camp in the target battleground and the connection relationship among the virtual objects.

In an optional implementation, the first processing module is configured to, in response to a resource allocation event being triggered, determine resource allocation information of each game camp in the game battleground based on the virtual object occupation information of each game camp in the game battleground; and allocate game resources based on the resource allocation information.

In an optional implementation, the game resources comprise: camp resources allocated to each game camp in the game battleground, and/or, game character resources allocated to game characters in each game camp in the game battleground.

In an optional implementation, the resource allocation event comprises at least one of: the current time reaching preset resource settlement time; or a third target virtual object in the virtual objects being occupied by any game camp.

In a fourth aspect, an embodiment of the present disclosure provides a game controlling apparatus, a scene of the game comprising a plurality of game camps, a plurality of virtual objects and connection relationships among the virtual objects; each game camp comprising a plurality of virtual characters; the apparatus comprising:
a sending module, configured to, in response to an interaction request of a target virtual character interacting with a first target virtual object in the plurality of virtual objects being triggered, send the interaction request to a server;
a second processing module, configured to, in response to an interaction request success response fed back by the server based on the interaction request, enable an interaction permission of the target virtual character interacting with the first target virtual object; wherein the interaction request success response is determined by the server according to virtual object occupation information of each game camp in a target battleground to which a game camp of the target virtual character belongs, and the connection relationship among the virtual objects.

In an optional implementation, the second processing module is configured to, when the interaction request is an attack request of attacking the first target virtual object, in response to the attack request succeeding, controlling the target virtual character to enter an attack scene of attacking the first target virtual object.

In an optional implementation, the second processing module is configured to obtaining a game resource allocated by the server to the target virtual character; wherein the game resource is determined by the server based on the virtual object occupation information corresponding to each game camp in the target battleground after a resource allocation event is triggered.

In a fifth aspect, an optional implementation of the present disclosure further provides a computer device, a processor and a memory, the memory storing machine-readable instructions executable to the processor, the processor being used for executing the machine-readable instructions stored in the memory, the machine-readable instructions, when executed by the processor, performing the first aspect or steps in any possible implementation of the first aspect; or performing the second aspect or steps in any possible implementation of the second aspect.

In a sixth aspect, an optional implementation of the present disclosure further provides a computer-readable storage medium, on which a computer program is stored, the computer program, when run by a processor, performing the first aspect or steps in any possible implementation of the first aspect; or performing the second aspect or steps in any possible implementation of the second aspect.

In a seventh aspect, an optional implementation of the present disclosure further provides a computer program product, comprising a computer program which, when run, performs the first aspect or steps in any possible implementation of the first aspect; or performs the second aspect or steps in any possible implementation of the second aspect.

In an eighth aspect, an optional implementation of the present disclosure further provides a computer program which, when run, performs the first aspect or steps in any possible implementation of the first aspect; or performs the second aspect or steps in any possible implementation of the second aspect.

In the game controlling method provided by the embodiments of the present disclosure, a scene of the game comprises a plurality of game camps, a plurality of virtual objects and connection relationships among the virtual objects; in response to a battleground establishment event being triggered, a game battleground is established; wherein the game battleground comprises at least one game camp; in response to an interaction request of a game camp for a first target virtual object, a belonging target battleground is determined according to a game camp of the requester, and then based on the target battleground being successfully determined, it is determined whether the game camp of the requester meets an interaction condition according to virtual object occupation information of each game camp in the target battleground and connection relationships among the virtual objects; if the game camp of the requester meets the interaction condition, then the request sent by the requester camp is successfully responded to, and an interaction operation on the first target virtual object may be initiated. Thus, a game battleground formed by different camps can be added based on game camps; for the interaction with a virtual object, it is determined whether an interaction condition is met based on virtual object occupation information corresponding to each camp in the game battleground, thereby enriching game styles. At the same time, it is flexible to form a battleground, thereby improving the fun of gaming.

In addition, according to the embodiments of the present disclosure, resource allocation information of all game camps in the game battleground is determined based on virtual object occupation information of each game camp in the game battleground, and game resources are allocated according to the resource allocation information, so that a plurality of game camps in the same game battleground can share the allocation of game resources, the allocation mode of game resources is enriched, and the diversity and flexibility of game styles are further increased.

To make the above objects, features and advantages of the present disclosure more apparent and understandable, a detailed illustration is presented below by way of preferred embodiments in cooperation with the accompanying drawings.

### BRIEF DESCRIPTION OF THE DRAWINGS

In order to more clearly illustrate the technical solution of the embodiments of the present disclosure, a brief introduction is presented below to the accompanying drawings used herein, which are incorporated into the specification to form a portion of the specification. These drawings show embodiments that conform to the present disclosure and are used to illustrate the technical solution of the present disclosure together with the specification. It should be understood that the accompanying drawings below merely show some embodiments of the present disclosure and should not be construed as limiting the scope. According to the accompanying drawings, those of ordinary skill in the art may further obtain other relevant drawings without the exercise of any inventive skill.

FIG. 1 shows a flowchart of a game controlling method provided by an embodiment of the present disclosure;

FIG. 2 shows a schematic diagram of a specific example of establishing a battleground after a second target virtual object is occupied for the first time by a first game camp as provided by an embodiment of the present disclosure;

FIG. 3 shows a schematic diagram of a specific example of in response to a first target virtual object being located in a first area, determining the first target virtual object has a direct connection relationship with a virtual object occupied by a first game camp in the target battleground and a second game camp in the target battleground initiating an attack request against the first target virtual object as provided by an embodiment of the present disclosure;

FIG. 4 shows a schematic diagram of a specific example of determining whether a third target virtual object can be occupied by any game camp as provided by an embodiment of the present disclosure;

FIG. 5 shows a flowchart of a game controlling method provided by an embodiment of the present disclosure;

FIG. 6 shows a schematic diagram of a specific example of taking a guild as a game camp for city siege as provided by an embodiment of the present disclosure;

FIG. 7 shows a schematic diagram of a game controlling apparatus provided by an embodiment of the present disclosure;

FIG. 8 shows a schematic diagram of a further game controlling apparatus provided by an embodiment of the present disclosure;

FIG. 9 shows a schematic diagram of a computer device provided by an embodiment of the present disclosure.

### DETAILED DESCRIPTION OF EMBODIMENTS

In order to make the objectives, technical solution and advantages of the embodiments of the present disclosure clearer, the technical solution provided in the embodiments of the present disclosure will be clearly and completely described in conjunction with the accompanying drawings. Apparently, the embodiments to be described are merely a portion rather than all of the embodiments of the present disclosure. Usually, components of the embodiments of the present disclosure described and illustrated herein may be arranged and designed in various configurations. Therefore, the following detailed description of the embodiments of the present disclosure is not intended to limit the protection scope of the present disclosure but merely represents selected embodiments of the present disclosure. Based on the embodiments of the present disclosure, all other embodiments obtained by those skilled in the art without the exercise of any inventive skill fall under the protection scope of the present disclosure.

Studies suggest that many games involve the gameplay of simultaneous online occupy of territories or cities by a plurality of players, in which players belong to different game camps, such as a family, a union, etc.; game camps can contend for territories or cities. The power of players will affect a result of the game camp's city occupy, the number of cities, and benefits gained. As a result, players have to constantly improve their own combat power and further their group's comprehensive combat power, in order to cause the group to obtain more benefits, i.e., game resources. Such a gameplay style is rather monotonous.

In addition, during the game, resources will be allocated according to the number of territories or cities occupied by the game camps. Thus, players with higher combat power will gather within some of game camps in order to obtain more game resources, and there is a big difference in the combat power of players in different game camps, which in turn causes a big difference in the overall combat power of different game camps. When occupying territories or cities, camps with higher overall combat power are more likely to gain a greater advantage, leading to a greater tilt in the allocation of in-game resources towards a smaller number of players and disrupting the balance of the game.

Based on the foregoing studies, the present disclosure provides a game controlling method, wherein a game scene comprises a plurality of game camps, a plurality of virtual objects and connection relationships between the virtual objects. In the method, a game battleground is established; in response to an interaction request from a game camp in the game battleground to a first target virtual object, it is determined whether the camp camp satisfies an interaction condition, according to virtual object occupation information of each game camp in the game battleground and connection relationships between the virtual objects; if the game camp satisfies the interaction condition, then the request sent by the game battleground is successfully responded to, and an interaction operation may be performed on the first target virtual object. Thus, the game battleground formed by different camps can be added based on game camps, and interaction with virtual objects is based on the occupation information of the virtual objects corresponding to each camp in the game battleground to determine whether the interaction condition is met, thus enriching the gameplay. At the same time, the formation of battlegrounds is more flexible, which enhances the fun of games.

In addition, according to the embodiments of the present disclosure, resource allocation information of all game camps in the game battleground is determined based on virtual object occupation information of each game camp, and game resources are allocated according to the resource allocation information, so that a plurality of game camps in the same game battleground can share allocated game resources, enriching the allocation mode of game resources, making the allocation of in-game resources more reasonable and reducing the damage to the game balance.

The drawbacks that exist in the above solutions result from the inventors' practice and careful study. Therefore, the discovery process of the above problems and solutions proposed by the present disclosure below for the above problems should be the inventors' contribution to the present disclosure in the course of the present disclosure.

It is noteworthy that similar numerals and letter represent similar items in the following drawings, so that once an item is defined in an accompanying drawing, it does not need to be further defined and explained in subsequent accompanying drawings.

For the sake of the understanding of this embodiment, first of all, a detailed description is presented to a game controlling method disclosed by the embodiments of the present disclosure. The execution body of the game controlling method disclosed here is generally a computer device with certain computing power, the computer device including, for example, a terminal device or a server or other processing device, the terminal device including, for example, a touch terminal and a personal computer (PC) terminal. The touch terminal includes, for example, a smart phone, a tablet computer, etc.; the PC terminal includes, for example, a desktop computer, a notebook computer, etc. In the terminal device, there are installed game programs corresponding to games. It is noteworthy that games may also run in a server, relevant data processing is performed with the server, and the terminal device, as a display device, displays data sent by the server. A game scene of a game comprises a plurality of game camps and a plurality of virtual objects, the game camp comprising a plurality of virtual characters; when the game program is running in the terminal device, a game picture of the game is presented via a graphical user interface of a display component, the game picture partially comprising the game scene. Wherein virtual characters may be displayed in game pictures, for example, in a third-person game, virtual characters may be displayed in game pictures; virtual characters may also not be displayed in game pictures, for example, in a first-person game, virtual characters may not be displayed in game pictures.

The game controlling method provided by the embodiments of the present disclosure are illustrated below. The execution body of the game controlling method may be a terminal device or a server.

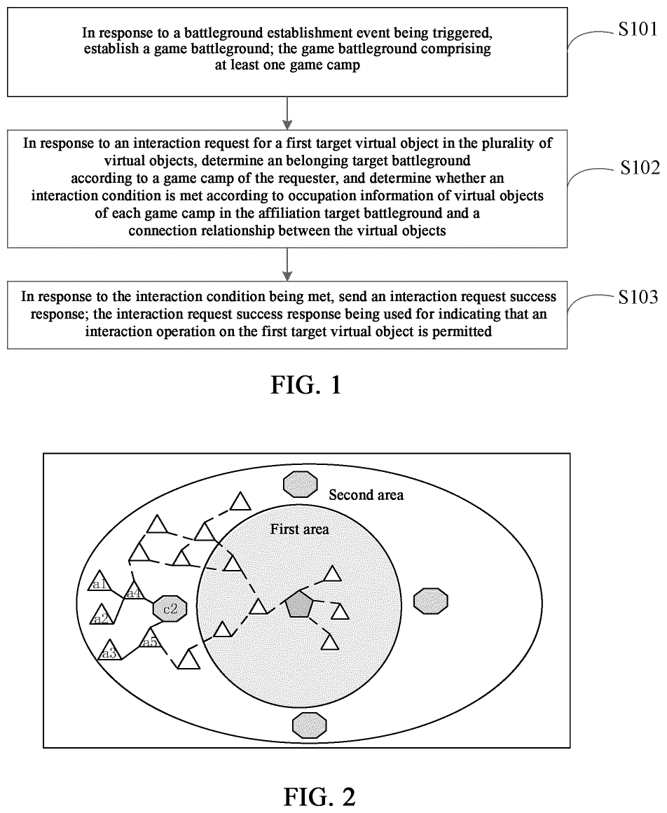

With reference to FIG. 1, this figure shows a flowchart of a game controlling method provided by the embodiments of the present disclosure. The method comprises steps S101˜S103, wherein,

S101: in response to a battleground establishment event being triggered, establishing a game battleground, the game battleground comprising at least one game camp;

S102: in response to an interaction request of interacting with a first target virtual object in the plurality of virtual objects, determining a belonging target battleground according to a game camp of a requester, and determining whether an interaction condition is met according to virtual object occupation information of each game camp in the belonging target battleground and the connection relationship among the virtual objects;

S103: in response to the interaction condition being met, sending an interaction request success response; the interaction request success response being used for indicating that an interaction operation on the first target virtual object is permitted.

In the game controlling method provided by the embodiments of the present disclosure, the game scene comprises a plurality of game camps, a plurality of virtual objects and connection relationships between the virtual objects, and an area of the game scene is divided into a first area (core area) and a second area (peripheral area); in response to a battleground establishment event being triggered, a game battleground is established, wherein the game battleground comprises at least one game camp; then, in response to an interaction request for a first target virtual object of the game battleground, a belonging target battleground is determined according to a game camp of the requester; whether an interaction condition is met is determined according to virtual object occupation information of each game camp in the target battleground and connection relationships among the virtual objects; if the game camp of the requester meets the interaction condition, then the request sent by the requester camp is successfully responded to, and an interaction operation may be initiated for the first target virtual object. Thus, on the basis of game camps, a game battleground formed by different camps may be added. Further, the interaction with the virtual object is based on the virtual object occupation information corresponding to each camp in the game battleground to determine whether the interaction condition is met, thereby enriching the gameplay style. At the same time, the way of forming battlegrounds is more flexible, increasing the flexibility of the gameplay style.

Detailed illustration of S101˜S103 is presented below.

Regarding S101, the game scene comprises a plurality of game camps, a plurality of virtual objects and connection relationships between the virtual objects.

As an example, the game camp includes, for example, a plurality of virtual characters, such as a union, a guild and a family in the game. The number of virtual characters in the game camp may be subjected to a certain upper limit. For example, the maximum number of virtual characters in the game camp is 100. When the number of virtual characters in a game camp reaches the upper limit, then virtual characters that have not joined the game camp cannot join the game camp; if the number of virtual characters in a game camp does not reach the upper limit, then virtual characters that have not joined the game camp may join the game camp through application.

Virtual objects include, for example, cities or territories in the game scene; the interaction request for the virtual object of the game camp may be, for example, a occupy request for cities or territories in the game scene, an exchange request for cities or territories with other game camp, a transfer requests for occupied cities or territories, or a sharing request for occupied cities or territories. The city or territory may be located in a peripheral area or a core area. In addition, each game camp has an initially occupied virtual object, i.e., a city or territory.

Wherein the interaction request is a occupy request and the occupy request succeeds, then the game camp requesting the occupy request may occupy a corresponding city or territory; if the occupy succeeds, then the game camp occupies the corresponding city or territory; the occupy fails, then the game camp cannot occupy the corresponding city or territory.

If the interaction request is an exchange request and the exchange request succeeds, the game camps (at least two) requesting the exchange request exchange the occupation rights of the occupied city or territory. For example, a game camp A has occupied a city a1, a game camp B has occupied a city a2, and the game camps A and B belong to the same game battleground; if an exchange request for exchanging the city a1 and the city a2 is triggered and succeeds, then the game camp A obtains the occupation rights of the city a2 and at the same time loses the occupation rights of the city a1; the game camp B obtains the occupation rights of the city a1 and at the same time loses the occupation rights of the city a2.

If the interaction request is a transfer request and the transfer request succeeds, then a transferee of the transfer request obtains the occupation rights of a city or territory corresponding to the transfer request. For example, the game camp A has occupied the city a1; if a transfer request for transferring the city a1 occupied by the game camp A to the game camp B (the game camp A and the game camp B belong to the same game battleground) is triggered and succeeds, at this point the game camp B is the transferee and the game camp A is the transferor, so the game camp B obtains the occupation rights of the city a1 and at the same time, the game camp A loses the occupation rights of the city a1.

If the interaction request is a sharing request and the sharing request succeeds, then the shared party of the sharing request obtains the occupation rights of the city or territory corresponding to the sharing request. For example, the game camp A has occupied the city a1, if the sharing request for sharing the city a1 occupied by the game camp A with the game camp B (the game camp A and the game camp B belong to the same game battleground) is triggered and succeeds, at this point the game camp B is the shared party and obtains the occupation rights of the city a1, and at the same time, the game camp A retains the occupation rights of the city a1. That is, the game camp A and the game camp B share the occupation rights of the city a1.

The connection relationship among the virtual objects include, for example, an indirect connection relationship and a direct connection relationship. The indirect connection relationship refers to that two virtual objects do not directly communicate with each other but establish a connection relationship through a third-party virtual object. For example, the game scene illustrated in FIG. 2 includes a city a1, a city a2, and a city a4; the city a1 and the city a2 are not directly connected, while the city a4 is connected to the city a1 and the city a2, respectively, and the city a1 and the city a2 have established an indirect connection relationship through the city a4. If two virtual objects are directly connected and do not need a third-party virtual object to establish a connection relationship, then the two virtual objects have a direct connection relationship; in the above example, the city a4 and the city a1 have a direct connection relationship, and the city a4 and the city a2 have a direct connection relationship.

A plurality of game camps in the game scene are, for example, game camps which are filtered and determined to be able to participate in the corresponding gameplay based on the total ranking of all the game camps included in the game server.

Taking guilds as game camps, cities as virtual objects, and a plurality of guilds contending for cities as an example, 16 game camps with the highest ranking points will be the game camps contending for cities. In addition, a game camp contending for areas may be determined according to the number of active players in the game camp and the combat power information of the virtual character in the game camp. The combat power information of the virtual character includes, for example, information capable of characterizing the combat power of the virtual character determined on the basis of the comprehensive attributes of the virtual character, such as combat power information determined on the basis of the equipment, attributes, virtual resources possessed by the virtual object, and association gains of the virtual object. For example, if a game camp has a larger number of active players and the combat power information of the players characterizes high combat power, then the game camp has the authority to join a city contention event.

For the game camp joining the city contention event, an initially occupied virtual object is allocated, and attribute information of the initially occupied virtual object includes at least one of: a low-level virtual object, and a randomly allocated virtual object located in an edge area of the game scene. The connection relationship among the virtual objects is preset, and connection relationships between various virtual objects may be displayed through a map in the game scene. Players contend for the virtual object through connection routes between the virtual objects as displayed by the map. For a virtual object which is not occupied by the game camp, it may be occupied by a non-player character (NPC) in the game, and the game camp needs to attack the virtual object occupied by the NPC in order to occupy the virtual object.

In addition, for a virtual object which is occupied by the game camp, other game camp may also contend for it.

When the game camp joins a game scene of area contention, the game camp will initiate a occupy request for the virtual object; in response to a successful occupation of a virtual object by a game camp, the game camp obtains access to game resources generated by the virtual object. When a second target virtual object in the plurality of virtual objects is occupied for the first time by a game camp that does not belong to any game battleground, a battleground establishment event will be triggered.

The embodiments of the present disclosure provide a specific example of establishing a game battleground in response to a battleground establishment event being triggered, comprising: in response to a second target virtual object in the plurality of virtual objects being occupied for the first time by a first game camp that does not belong to any game battleground, establishing a game battleground, wherein the game battleground comprises the first game camp.

As shown in FIG. 2, the game scene is divided into two areas, a first area and a second area. The game scene comprises a first game camp A, virtual objects initially occupied by the first game camp comprise a1, a2 and a3, and the first game camp captures two virtual objects a4 and a5 in subsequent games, wherein connection relationships between occupied virtual objects are represented by solid lines, and connection relationships between unoccupied and occupied virtual objects are represented by dashed lines in the figure. The second target virtual object c2 is within the second area. When the virtual object occupied by the first game camp A has a direct connection relationship with the second target virtual object, an attack may be initiated to the second target virtual object c2. In the example shown in FIG. 2, since both the virtual objects a4 and a5 occupied by the first game camp A have a direct connection relationship with the second target virtual object, the first game camp A can initiate attack to the second target virtual object c2; after the second target virtual object c2 is successfully occupied, since the second target virtual object c2 is not occupied by any other game camp before being occupied by the first game camp, the battleground establishment event is triggered, establishing a game battleground that includes the first game camp A.

After the first game camp establishes the game battleground, the status of the battleground may be determined according to either of the following situation:
(1) Once a game battleground is established, the game battleground will always exist no matter whether the second target virtual object corresponding to the game battleground is occupied by other game camp.

For example, the game camp A occupies the second target virtual object c2 and establishes the game battleground comprising the game camp A; if the second target virtual object c2 is later occupied by the game camp B, the game battleground comprising the game camp A still exists, and no new game battleground will be established.
(2) Once a game battleground is established, if the second target virtual object corresponding to the game battleground is occupied by other game camp, then the game battleground is dissolved, and a new game battleground is established based on other game camp occupying the second target virtual object. Here, the other virtual camp comprises a game camp that does not belong to any game battleground.

For example, the game camp A occupies the second target virtual object c2 and establishes the game battleground comprising the game camp A; if the second target virtual object c2 is later occupied by the game camp B, and B does not belong to any game battleground before occupying the second target virtual object c2, then the game battleground comprising the game camp A is dissolved, and a new game battleground comprising the game camp B is established.

After the game battleground is successfully established, in response to a battleground joining event corresponding to joining the game battleground is triggered, a second game camp triggering the battleground joining event is controlled to join the game battleground.

For example, after the game camp A captures the second target virtual object for the first time, a game battleground taking the game camp A as the core will be established. When the game camp B that has not joined other game battlegrounds triggers a battleground joining event and the game camp A agrees with the game camp to join, the game camp A will control the game camp B to join the game battleground.

In a specific example of the embodiment of the present disclosure, the controlling, after a game battleground is successfully established, in response to a battleground joining event corresponding to joining the game battleground is triggered, a second game camp that triggers the battleground joining event to join the game battleground comprises:

In response to a battleground joining event corresponding to joining the game battleground being triggered, determining whether the number of game camps included in the game battleground reaches a preset number threshold, and determining whether the first game camp agrees with the second game camp to join the game camp;

In response to the number of game camps included in the game battleground not reaching the preset number threshold and the first game camp agreeing with the second game camp to join the game battleground, controlling the second game camp to join the game battleground.

As an example, in response to a battleground joining event being triggered, it is determined whether the number of game camps in the game battleground reaches a preset number threshold; if the number of game camps in the game camp does not reach the preset number threshold, and the first game camp agrees with a second game camp that triggers the game battleground joining event to join the game battleground, then the second game camp is controlled to join the game battleground.

If the first game camp does not agree with a second game camp that triggers the game battleground joining event to join the game battleground, then the second game camp fails to join the game battleground.

As an example, if the number of game camps in the game battleground reaches the preset number threshold, then the second game camp fails to join the game battleground.

In addition, in a further embodiment, if the number of game camps in the game battleground reaches the preset number threshold, when the first game camp receives a joining request from the second game camp, the first game camp may select to delete any game camp in the game battleground, and after any game camp is selected, if the first game camp agrees with the second game camp to join the game battleground, the second game camp succeeds in joining the game battleground.

In a further embodiment, after a game battleground is established, a second game camp may be automatically assigned to each game battleground. For example, the current game state of each game camp that does not belong to any game battleground can be measured, such as combat power information, the number of occupied virtual objects, the location of an occupied virtual object, etc., and a second game camp can be determined for each game battleground; after the second game camp is determined, the second game camp joins a corresponding game battleground.

For example, when automatically assigning a second game camp to each game battleground, for example, according to the combat power information of each game camp, the overall combat power of each game camp may be ranked (the overall combat power of each game camp may be determined according to combat power information of virtual characters in the game camp, or determined according to historical combat records). According to the ranking, the second game camp is assigned to each game battleground with the goal of equalizing as much as possible the combat power of game camps in different battlegrounds.

For another example, when automatically assigning a second game camp to each game battleground, for example, according to the number of virtual objects occupied by each game camp, the game camps may be ranked according to the number of virtual objects occupied by each game camp, and then according to the ranking, the second game camp is assigned to each game battleground with the goal of equalizing as much as possible the number of virtual objects occupied by game camps in different battlegrounds.

For another example, when automatically assigning a second game camp to each game battleground, for example, according to locations of virtual objects occupied by each game camp, the second game camp is assigned to each game battleground according to locations of virtual objects occupied by each game camp, with the goal of scattering as much as possible locations of virtual objects occupied by different game camps belonging to the same game battleground, or with the goal of gathering as much as possible locations of virtual objects occupied by different game camps belonging to the same game battleground.

With respect to S102, in a specific example of the embodiments of the present disclosure, the determining, in response to an interaction request of interacting with a first target virtual object in the plurality of virtual objects, whether a belonging target battleground of the requester satisfies an interaction condition comprises:
In response to an interaction request of interacting with a first target virtual object in the plurality of virtual objects, determining a belonging target battleground according to a game camp of the requester;
In response to the target battleground being successfully determined, determining whether the interaction condition is met according to virtual object occupation information of each game camp in the target battleground and connection relationships among the virtual objects;
In response to the failure of determining the target battleground, determining whether the interaction condition is met according to virtual object occupation information of a game camp corresponding to the interaction request and connection relationships among the virtual objects.

In specific implementation, after receiving the interaction request for the first target virtual object, the server will determine a belonging target battleground according to a game camp of the requester, wherein the requester is a player-controlled virtual character with requesting permissions in any game camp.

Taking a guild as an example of the game camp, virtual characters with requesting permissions include, for example, a guild president, and a guild vice president. Taking a family as an example of the game camp, virtual characters with requesting permissions include, for example, a family patriarch.

A terminal device corresponding to the virtual character with requesting permissions in the game camp, after receiving the interaction request for the first target virtual object, can send the interaction request to the server. In response to receiving the interaction request, the server determines a belonging target battleground according to a game camp of the requester.

When determining the belonging target battleground, there might exist either of the following situations:

First: the game camp of the requester has joined a certain game battleground, at which point, the target battleground can be successfully determined.

Where the target battleground is successfully determined, it is determined whether the interaction condition is met according to virtual object occupation information of each game camp in the target battleground and connection relationships among the virtual objects.

Here, the virtual object occupation information includes, for example, locations or identifiers of virtual objects occupied by the game camp in the game scene.

When determining whether the interaction condition is met, for example,

According to virtual object occupation information of each game camp in the target battleground and the connection relationship among the virtual objects, it is determined whether the first target virtual object has a direct connection relationship with the virtual object occupied by the game camp in the target battleground or not; in response to YES, then it is determined that the interaction condition is met.

As an example, the area in the game scene comprises: a core area (e.g., a first area in the following embodiments) and a peripheral area (e.g., a second area in the following embodiments); the server judges whether the interaction condition is met depending on whether the location of the virtual object occupied by the game camp in the game scene is in the core area and the connection relationship among the virtual objects; if the first target virtual object is located in the core area and the virtual object occupied by any game camp in the target battleground has a direct connection relationship with the first target virtual object, then the interaction condition is met. In this case, the connection relationship is only shared in the core area, and connection relationships in the peripheral area cannot be shared. Thus, the virtual object occupied by each game camp in the peripheral area can form a certain area range, and the chance that the first target virtual object in the first area is occupied is increased, which enhances the fun.

As an example, each virtual object in the computing device has a unique identifier, and the server may store identifiers corresponding to two virtual objects with a direct connection relationship in the form of an identifier pair. At the same time, the server further stores a guild relationship between the identifier and the game camp, the guild relationship between the identifier and the game camp characterizing virtual object occupation information of each game camp.

After the interaction operation on the first target virtual object is triggered, the server may read from all identifier pairs an identifier pair (s1, s2) that comprises the identifier of the first target virtual object, wherein s1 is the identifier of the first target virtual object and s2 is an identifier of the other virtual object having a direct connection relationship with the first target virtual object, and there is at least one identifier pair. Then, according to the guild relationship between s2 and the game camp, it is judged whether the virtual object corresponding to s2 is occupied by any game camp in the target battleground or not. In response to YES, it characterizes that the interaction condition is met.

In another example, the virtual object occupied by any game camp in the target battleground has a direct connection relationship with the first target virtual object, no matter whether the location of the first target virtual object belongs to the core area, it is determined that the interaction condition is met. Thus, virtual objects occupied by each game camp in the peripheral area may not have a direct connection relationship, allowing for more tactical diversity.

In addition, the virtual object occupation information may further comprise: the number of occupied virtual objects, locations of occupied virtual objects and other information.

Taking the virtual object occupation information comprising the number of occupied virtual objects as an example, the larger the number of virtual objects occupied by the game camp, the larger the number of virtual objects that can initiate an interaction request in the same time period. Thus, after the interaction operation on the first target virtual object is triggered, it may be determined, according to the number of virtual objects occupied by each game camp in the target battleground, whether the number of the first target virtual objects corresponding to the interaction operation exceeds an upper limit on the number of virtual objects on which the interaction operation is allowed or not; if not, then the interaction condition is met.

Taking the virtual object occupation information comprising locations of virtual objects as an example, when the game camp initiates the interaction operation, only after the game camp captures virtual objects in some specific locations, it can perform the interaction operation on a virtual object in another specific location. Thus, after it is determined whether the interaction operation on the first target virtual object is met, it is determined, according to locations of virtual objects occupied by each game camp in the target battleground, whether virtual objects in specific locations to be occupied before the first target virtual object is occupied are occupied or not; in response to YES, then it is determined that the interaction condition is met.

In addition, in a further embodiment, a preset time period for initiating contention may be set, during which the game camp can initiate contention for the first target virtual object. After obtaining a successful response to the interaction request, the game camp may contend for the first target virtual object during another time period.

The preset time period is set in advance, and the game camp performs different interaction operations at different times. The preset time period comprises: a truce period, a declaration of combat period, a preparation period, and a combat period. The game camp initiates the interaction request on the first target virtual object in the truce period; after the game camp satisfies the interaction condition, the game camp's occupy the first target virtual object is performed in the combat period; when the game state is in the truce period, each game camp will automatically withdraw from the game occupy scene, and the game camp cannot initiate a occupy in the truce period; when the state of the game is in the preparation period, the game camp will gather each virtual character to prepare to enter the combat period.

For another example, if the requester game camp launches an attack on the first target virtual object, and the requester game camp fails to occupy the first target virtual object, then the first target virtual object belongs to the original game camp, or belongs to the NPC camp; if the requester game camp succeeds in occupying the first target virtual object, the first target virtual object belongs to the requester game camp.

In addition, if the target battleground fails to be determined, i.e., the requester game camp does not join any battleground, then it is determined according to virtual object occupation information of the requester game camp whether the requester game camp meets the interaction condition; if the requester game camp meets the interaction condition, it may launch an attack on the first target virtual object. Wherein the virtual object occupation information includes, for example, the number, level, location, identifier and other information of virtual objects occupied by the requester game camp.

In a specific example of the embodiments of the present disclosure, the determining, according to the virtual object occupation information of each game camp in the target battleground and connection relationships among the virtual objects, whether the first target virtual object and the virtual object occupied by the game camp in the target battleground have a direct connection relationship comprises:

Determining whether the first target virtual object is located in the first area;

In response to the first target virtual object being located in the first area, determining, according to the virtual object occupation information of each game camp in the target battleground and connection relationships among the virtual objects, whether the first target virtual object and the virtual object occupied by the game camp in the target battleground have a direct connection relationship.

As an example, in response to the first target virtual object being located in the first area, it is determined, according to the virtual object occupation information of each game camp in the target battleground and connection relationships among the virtual objects, whether the first target virtual object and the virtual object occupied by the game camp in the target battleground have a direct connection relationship; if the first target virtual object and the virtual object occupied by the game camp in the target battleground have a direct connection relationship, then the requester game camp launches an attack on the first target virtual object, and at the same time, other game camp belonging to the target battleground shares the connection relationship between the requester game camp and the first target virtual object to launch an attack on the first target virtual object at a distance.

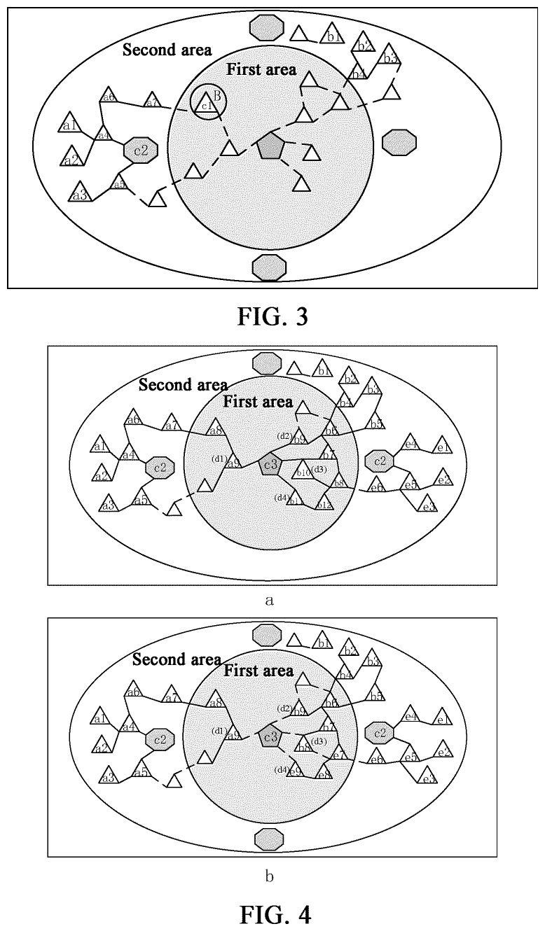

With reference to FIG. 3, the game scene is divided into two areas: a first area and a second area; the game scene comprises a plurality of virtual objects, a first game camp A and a second game camp B; the target battleground comprises the first game camp A and the second game camp B, initial virtual objects of the first game camp comprise a1, a2 and a3, initial virtual objects of the second game camp comprise b1, b2 and b3; the first target virtual object c1 is located in the first area, and the first game camp A and the first target virtual object c1 have a direct connection relationship; connection relationships between occupied virtual objects are represented by solid lines, and connection relationships between unoccupied virtual objects are represented by dashed lines; when the first game camp A launches an attack on the first target virtual object c1, the direct connection relationship between the city a7 occupied by the first game camp A and the first target virtual object may be shared with the second game camp B belonging to the same battleground, and the second game camp B may attack the first target virtual object c1 at a distance. As an example, since the first game camp A may share the direct connection relationship between the c1 and the occupied city a7 with the second game camp B belonging to the same battleground, the second game camp B may also directly initiate a occupy request for the first target virtual object c1.

As an example, in response to the first target virtual object being located in the first area, according to the virtual object occupation information of each game camp in the target battleground and the connection relationship between the occupied virtual objects, it is determined whether the first target virtual object and the virtual object occupied by the game camp in the game battleground have a direct connection relationship or not; if not, then the requester game camp should not launch an attack on the first target virtual object.

In S103, in response to the interaction condition being met, an interaction request success response is sent; the interaction request success response is used for indicating that the interaction operation on the first target virtual object is permitted.

Based on that the game camp initiates an interaction request for the first target virtual object and the request is successfully responded to, the game camp can enter a game occupy scene to occupy the first target virtual object; if the game camp successfully captures the first target virtual object, then game resources generated by the first target virtual object will be obtained the game camp and the game battleground to which the game camp belongs.

In the embodiments of the present disclosure, in response to a resource allocation event being triggered, resource allocation information of each game camp in the game battleground is determined based on virtual object occupation information of each game camp in the game battleground; the resource allocation information comprises: a combat power output value, a defense value and an active value.

The resource allocation event comprises at least one of:
A: the current time reaches preset resource settlement time;
For example, the resource settlement of the day is conducted according to daily occupied virtual object information of the game camp, the occupied virtual object information comprising the number, level, and location information of the virtual object; when the number of virtual objects occupied by the game camp is larger, the level of the virtual object is high and the virtual object is located in the core area, the game camp obtains more resources; or at the end of a season, the season gross settlement is conducted according to the performance of the game camp, the season settlement resources comprising occupied virtual object information of the game camp in the season, and resource sharing of virtual objects occupied by a plurality of game camp in the game battleground.
B: a third target virtual object in the virtual objects being occupied by any game camp.

That the third target virtual object is successfully occupied needs to meet such a condition that all virtual objects having a direct connection relationship with the third target virtual object are occupied by game camps in the target battleground.

If any one of virtual objects having a direct connection relationship with the third target virtual object is occupied by a game camp in other game battleground, any game camp in the target battleground cannot initiate an attack request for the third target virtual object; if all virtual objects having a direct connection relationship with the third target virtual object are occupied by each game camp in the target battleground, the game camp in the target battleground initiates an attack request on the third target virtual object; when any game camp in the target battleground successfully captures the third target virtual object, the third target virtual object belongs to the game camp in the target battleground which successfully captures the third target virtual object.

With reference to FIG. 4, the game scene comprises a first game camp A and a second game camp B in the target battleground, a third game camp E in other game battleground, a third target virtual object c3 and virtual objects d1, d2, d3 and d4 each with a direct connection relationship with c3; initial virtual objects of the first game camp A comprise a1, a2 and a3, initial virtual objects of the second game camp B comprise b1, b2 and b3, and initial virtual objects of the third game camp E comprise e1, e2 and e3; connection relationships between occupied virtual objects are represented by solid lines, and connection relationships between unoccupied virtual objects are represented by dashed lines; as shown in a of FIG. 4, if both the first game camp A and the second game camp B occupy the virtual objects d1, d2, d3 and d4, then any game camp in the target battleground, i.e., the first game camp A and the second game camp B, can initiate an attack request on the third target virtual object c3.

As shown in b of FIG. 4, the game scene comprises a first game camp A and a second game camp B in the target battleground, a third game camp E in other game battleground, a third target virtual object c3 and virtual objects d1, d2, d3 and d4 each with a direct connection relationship with c3; connection relationships between occupied virtual objects are represented by solid lines, and connection relationships between unoccupied virtual objects are represented by dashed lines; if both the first game camp A and the second game camp B occupy the virtual objects d1, d2 and d3, while the third game camp captures the virtual object d4, then any game camp in the target battleground, i.e., the first game camp A and the second game camp B, cannot initiate an attack request on the third target virtual object c3.

As an example, that the third target virtual object is successfully occupied needs to meet such a condition that a preset number of virtual objects with a direct connection relationship with the third target virtual object are occupied by the game camp in the target battleground.

For example, during the game, when the third target virtual object is occupied by any game camp, i.e., a current season ends, a settlement is conducted according to occupied virtual object information of the game camp at this time and resource sharing of occupied virtual objects of each game camp in the game battleground, and the game battleground to which the game camp occupying the third target virtual object belongs will obtain extra resources. Game resources are allocated based on the resource allocation information. For example, the larger the number of virtual objects occupied by a certain game camp in the game battleground during the game and the higher the level of the virtual object, the higher the combat power output value and the defense value corresponding to the game camp. If the game camp frequently attacks other virtual object that does not belong to the game battleground during the game, then the active value corresponding to the game camp is high.

The game resources comprise: camp resources allocated to each game camp in the game battleground, and/or game character resources allocated to each game camp in the game battleground. The game resources comprise: attack props (e.g., equipment, etc.), gain state, and in-game materials (e.g., materials used to make medicines, equipment, buildings, etc.).

For example, judging by the number of resource types available to the game camp, corresponding resource types are allocated; if there are fewer attack props in the game camp, attack prop resources are increased in the resource settlement; or players may independently select which type of game resources is to be increased in the settlement.

As an example, the number of game resources obtained by each game camp is determined according to the combat power output value, the defense value and the active value of the game camp; if the game camp has a higher combat power output value, defense value and active value, then more camp resources will be allocated to the game camp; based on the obtained camp resources, the number of resources obtained by the player in the game camp is determined according to the level information, combat power output situation and active value of the player; if the player has a high level, a high active value during the game and a high output value in the area fighting, then the player will obtain more game character resources.

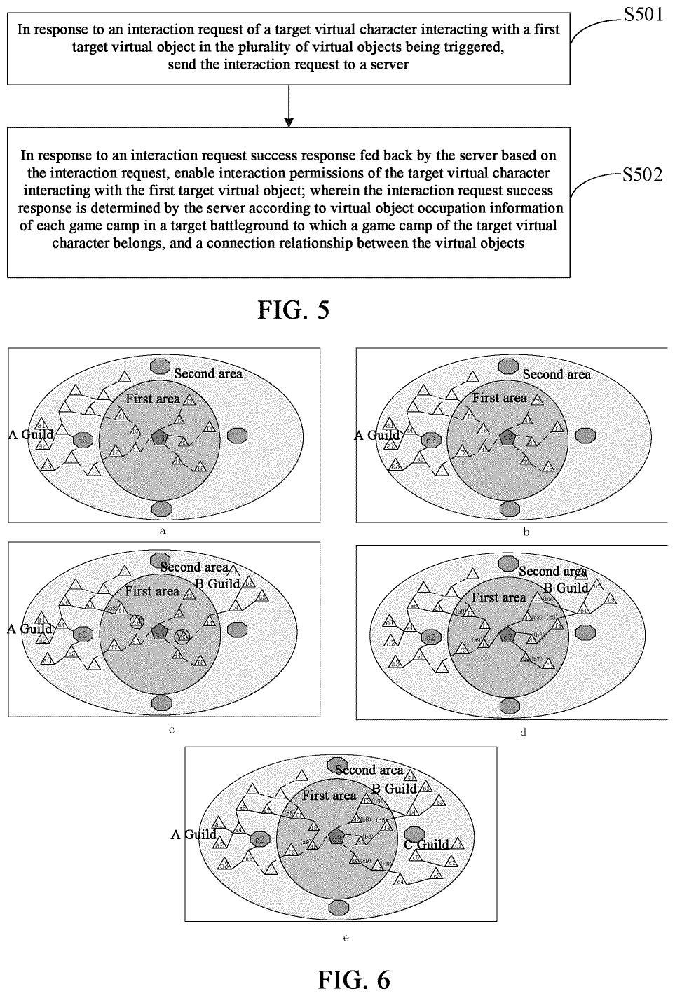

The embodiments of the present disclosure further provide a game controlling method, applied to a client. With reference to FIG. 5, this figure shows a flowchart of a further game controlling method provided by an embodiment of the present disclosure. The method comprises S501 and S502, wherein,

S501: in response to an interaction request of a target virtual character interacting with a first target virtual object in the plurality of virtual objects being triggered, sending the interaction request to a server;

S502: in response to receiving an interaction request success response fed back by the server based on the interaction request, enabling an interaction permission of the target virtual character to the first target virtual object, wherein the interaction request success response is determined by the server according to virtual object occupation information of each game camp in the target battleground to which the game camp of the target virtual character belongs, and the connection relationship among the virtual objects.

In S501, each game camp comprises a plurality of virtual characters, and interaction request is an attack request of attacking the first target virtual object; the player controls the target virtual character to initiate an attack request of attacking the first target virtual object to the server, and the server, upon receiving the request, feeds the request to the target virtual character and controls the target virtual character whether to enter an attack scene of attacking the first target virtual object; the attack scene comprises: the game camp simultaneously attacking the first target virtual object or an attack operation of the game camp on the first target virtual object.

Based on the player controlling the target virtual character to initiate an interaction request to the first target virtual object, if the server successfully responds to the attack request, the target virtual character is controlled to enter an attack scene of attacking the first target virtual object, and the target virtual character together with other virtual characters belonging to the game camp attack the first target virtual object.

In S502, the server receives the interaction request success response, which is determined by the server according to virtual object occupation information of each game camp in the target battleground to which the game camp requesting the target virtual character belongs, and the connection relationship among the virtual objects; wherein the way of the server determining a successful response may be referred to the corresponding embodiment of FIG. 1, which is not detailed here.

In addition, with respect to the attack permissions of the target virtual character to the first target virtual object being enabled, if the game camp to which the target virtual character belongs fails to occupy the first target virtual object, the occupation state of the virtual object for the game camp to which the target virtual character belongs returns to the state before requesting to attack the first target virtual object.

If the game camp to which the target virtual character belongs succeeds in occupying the first target virtual object, then the game camp to which the target virtual character belongs obtains occupation permissions to the first target virtual object. If the first target virtual object is successfully occupied, then the target virtual character may enter a sub-scene corresponding to the first target virtual object, or perform operations on the first target virtual object within the permissions range, such as construction operations, operations to increase the gain state, etc.

In a further embodiment, there is further comprised: obtaining a game resource allocated by the server to the target virtual character; wherein the game resource is determined by the server based on virtual object occupation information corresponding to each game camp in the target battleground after the resource allocation event is triggered. The specific way of determining the game resource may be referred to the corresponding embodiment of FIG. 1, which is not detailed here.

The embodiments of the present disclosure further provide a specific example of taking a guild as the game camp to besiege a city, comprising: in response to a ranking situation of points in the entire area of the game, determining 16 guilds with top rankings of points to enter a city siege gameplay; based on the guild s entering the city siege game, allocating 3 initial birth cities to each association, attribute information of the initial birth city comprising: randomly allocated, low-level, and map-edge cities; in response to a state city (a second target virtual object) being occupied by a guild not belonging to any game battleground, establishing game battlegrounds each of which comprises the guild that captures the state city and three ordinary guilds that do not occupy the state city, and then, on the basis of the game battlegrounds, guilds in the game battlegrounds sharing a connection relationship between occupied cities and sharing resource allocation; based on the connection relationship between cities, besieging other city and the King's City (a third target virtual object), settling game resources once at 0:00 each day during the season; performing a total resource settlement at the end of the season.

With reference to FIG. 6, taking a guild A as an example, the entire game scene is divided into a peripheral birth area and a core area, i.e., a second area and a first area; peripheral area cities are divided into birth cities, a state city c2 and contestable cities, and core area cities are divided into: 6 peripheral connecting cities f1, f2, f3, f4, f5, and f6, 4 key cities d1, d2, d3, and d4 connected to the King's City, and 1 King's City c3; connection relationships between occupied virtual objects are represented by solid lines, and connection relationships between unoccupied virtual objects are represented by dashed lines in the game scene; as shown in a of FIG. 6, first, three birth cities a1, a2 and a3 are randomly allocated to the guild A.

As shown in b of FIG. 6, the guild A can besiege cities a4 and a5 having a connection relationship with the state city c2 during the declaration of combat period before besieging the state city; after the guild A successfully captures cities a4 and a5, they launch a siege of the state city; if the guild A successfully captures the state city c2, the game battleground with the guild A as the leader will be established automatically.

As shown in c of FIG. 6, the game scene further comprises a guild B, the guild B being in the same game battleground as the guild A. Birth cities of the guild A comprise 1b1, b2 and b3. During the game, after the guild A successfully captures the city f1 (a8) in the core area, it will enable game resource sharing permissions in the same battleground and connection relationship sharing between cities occupied by guilds. When the guild A besieges the city f6, the guild B in the game battleground may attack f6 at a distance, and the guild A may also attack d3 at a distance.

As shown in d of FIG. 6, when both the guild s A and B occupy the four cities d1, d2, d3 and d4 each having a connection relationship with the city of the king c3, i.e., d1 is occupied by the guild A, and d2, d3 and d4 are all occupied by the guild B as shown, at this point the guild A and game camps in the game battleground to which the guild A belongs may launch a siege of the city of the king c3, and after the siege succeeds, they share resources in the same battleground.

As shown in e of FIG. 6, among the four cities d1, d2, d3 and d4 each having a connection relationship with the city of the king c3, if d4 is occupied by a guild C in other game battleground, then the guild A and game camps in the game battleground to which the guild A belongs cannot launch a siege of the city of the king c3.

Those skilled in the art may understand that in the above specific implementations of the methods, the drafting order of various steps does not imply any limitation of the implementation process by implying a strict order of execution, and the specific execution order of the steps should be determined by their function and possible internal logic.

Based on the same inventive concept, the embodiments of the present disclosure further provide a game controlling apparatus corresponding to the game controlling method. Since the principle of the apparatus solving the problem in the embodiments of the present disclosure is similar to that of the game controlling method described above, the implementation of the apparatus may be referred to that of the method, and repetitions are omitted here.

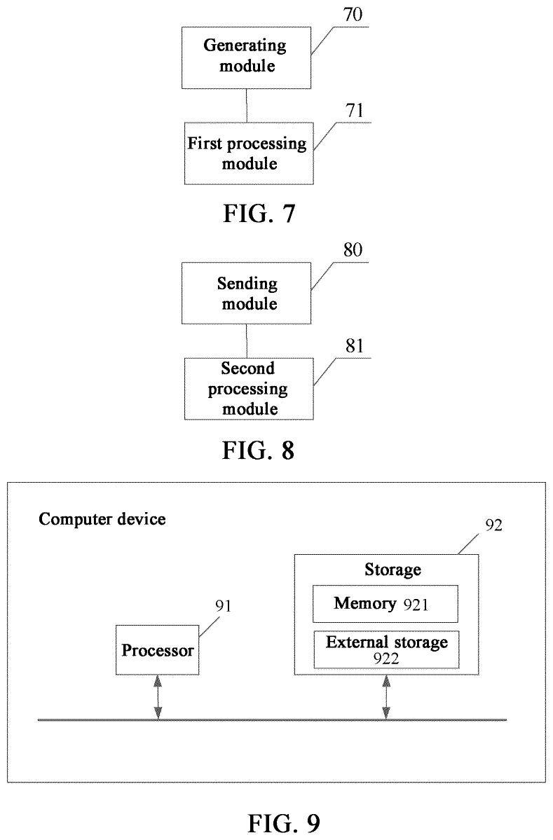

With reference to FIG. 7, this figure shows a schematic diagram of a game controlling apparatus provided by the embodiments of the present disclosure. The apparatus comprises: a generating module 70, and a first processing module 71, wherein,
the generating module 70 is configured to in response to a battleground establishment event being triggered, establish a game battleground, the game battleground comprising at least one game camp;
the first processing module 71 is configured to in response to an interaction request of interacting with a first target virtual object in the plurality of virtual objects, determine a belonging target battleground according to a game camp of a requester, and determine whether an interaction condition is met according to virtual object occupation information of each game camp in the belonging target battleground and the connection relationship among the virtual objects; in response to the interaction condition being met, send an interaction request success response, the interaction request success response being used for indicating that the interaction operation on the first target virtual object is permitted.

In an optional implementation, when, in response to a battleground establishment event being triggered, establish the game battleground, the generating module 70 is configured to in response to a second target virtual object in the plurality of virtual objects being occupied for a first time by a first game camp that does not belong to any game battleground, establishing the game battleground; wherein the game battleground comprises the first game camp.

In an optional implementation, the first processing module 71 is configured to in response to a battleground joining event corresponding to joining the game battleground being triggered, control a second game camp that triggers the battleground joining event to join the game battleground.

In an optional implementation, when, in response to the battleground joining event corresponding to joining the game battleground being triggered, control the second game camp that triggers the battleground joining event to join the game battleground, the first processing module 71 is configured to, in response to the battleground joining event corresponding to joining the game battleground being triggered, determine whether a number of game camps included in the game battleground reaches a preset number threshold and determine whether the first game camp agrees with the second game camp to join the game battleground; and in response to the number of the game camps included in the game battleground not reaching the preset number threshold and the first game camp agreeing with the second game camp to join the game battleground, control the second game camp to join the game battleground.

In an optional implementation, when, in response to the interaction request of interacting with the first target virtual object in the plurality of virtual objects, determining the belonging target battleground according to the game camp of the requester, and determining whether the interaction condition is met according to the virtual object occupation information of each game camp in the belonging target battleground and the connection relationship among the virtual objects, the first processing module 71 is configured to, in response to the interaction request of interacting with the first target virtual object in the plurality of virtual objects, determining the belonging target battleground according to the game camp of the requester; in response to the target battleground being successfully determined, determining whether the interaction condition is met according to the virtual object occupation information of each game camp in the target battleground and the connection relationship among the virtual objects; and in response to the target battleground failing to be determined, determining whether the interaction condition is met according to the virtual object occupation information of the game camp corresponding to the interaction request and the connection relationship among the virtual objects.

In an optional implementation, when, in response to the target battleground being successfully determined, determining whether the interaction condition is met according to the virtual object occupation information of each game camp in the target battleground and the connection relationship among the virtual objects, the first processing module 71 is configured to determining whether the first target virtual object has a direct connection relationship with a virtual object occupied by a game camp in the target battleground according to the virtual object occupation information of each game camp in the target battleground and the connection relationship among the virtual objects; and in response to YES, determining that the interaction condition is met.

In an optional implementation, the plurality of virtual objects comprise: a first virtual object located in a first area, and a second virtual object located in a second area; when determine whether the first target virtual object has the direct connection relationship with the virtual object occupied by the game camp in the target battleground according to the virtual object occupation information of each game camp in the target battleground and the connection relationship among the virtual objects, the first processing module 71 is configured to determine whether the first target virtual object is located in the first area; and in response to the first target virtual object being located in the first area, determine whether the first target virtual object has the direct connection relationship with the virtual object occupied by the game camp in the target battleground according to the virtual object occupation information of each game camp in the target battleground and the connection relationship among the virtual objects.

In an optional implementation, the first processing module 71 is configured to, in response to a resource allocation event being triggered, determine resource allocation information of each game camp in the game battleground based on the virtual object occupation information of each game camp in the game battleground; and allocate game resources based on the resource allocation information.

In an optional implementation, the game resources comprise: camp resources allocated to each game camp in the game battleground, and/or, game character resources allocated to game characters in each game camp in the game battleground.

In an optional implementation, the resource allocation event comprises at least one of: the current time reaching preset resource settlement time; or a third target virtual object in the virtual objects being occupied by any game camp.

With reference to FIG. 8, this figure shows a schematic diagram of a further game controlling apparatus provided by the embodiments of the present disclosure. The apparatus comprises: a sending module 80, and a second processing module 81, wherein,
the sending module 80 is configured to, in response to an interaction request of a target virtual character interacting with a first target virtual object in the plurality of virtual objects being triggered, send the interaction request to a server;
the second processing module 81 is configured to, in response to an interaction request success response fed back by the server based on the interaction request, enable an interaction permission of the target virtual character interacting with the first target virtual object; wherein the interaction request success response is determined by the server according to virtual object occupation information of each game camp in a target battleground to which a game camp of the target virtual character belongs, and the connection relationship among the virtual objects.

In an optional implementation, the second processing module 81 is configured to, when the interaction request is an attack request of attacking the first target virtual object, in response to the attack request succeeding, controlling the target virtual character to enter an attack scene of attacking the first target virtual object.

In an optional implementation, the second processing module 81 is configured to obtaining a game resource allocated by the server to the target virtual character; wherein the game resource is determined by the server based on the virtual object occupation information corresponding to each game camp in the target battleground after a resource allocation event is triggered.

For the description of the processing flow of each module in the apparatus and the interaction flow between various modules, reference may be made to the relevant illustration in the above method embodiments, which is not detailed here.

The embodiments of the present disclosure further provide a computer device. As shown in FIG. 9, this figure shows a structural schematic diagram of a computer device provided by the embodiments of the present disclosure, comprising:
a processor 91 and a storage 92; the storage 92 storing the processor 91 executable machine-readable instructions, the processor 91 being used for executing the machine-readable instructions stored in the storage 92, the machine-readable instructions, when executed by the processor 91, causing the processor 91 to perform the following steps:
in response to a battleground establishment event being triggered, establishing a game battleground, the game battleground comprising at least one game camp;
in response to an interaction request of interacting with a first target virtual object in the plurality of virtual objects, determining a belonging target battleground according to a game camp of a requester, and determining whether an interaction condition is met according to virtual object occupation information of each game camp in the belonging target battleground and the connection relationship among the virtual objects;
in response to the interaction condition being met, sending an interaction request success response; the interaction request success response being used for indicating that an interaction operation on the first target virtual object is permitted.
or performing the following steps:
in response to an interaction request of a target virtual character interacting with a first target virtual object in the plurality of virtual objects being triggered, sending the interaction request to a server;
in response to an interaction request success response fed back by the server based on the interaction request, enabling an interaction permission of the target virtual character interacting with the first target virtual object; wherein the interaction request success response is determined by the server according to virtual object occupation information of each game camp in a target battleground to which a game camp of the target virtual character belongs, and the connection relationship among the virtual objects.

The storage 92 comprises a memory 921 and an external storage 922; here the memory 921 is also referred to as an internal storage for temporarily storing operational data in the processor 91 and data exchanged with the external storage 922 such as a hard disk, the processor 91 exchanging data with the external storage 922 via the memory 921.

The specific execution process of the instructions may be referred to the steps of the game controlling method in the embodiments of the present disclosure, which is not detailed here.

The embodiments of the present disclosure further provide a non-transitory computer-readable storage medium, on which a computer program is stored, the computer program, when run by a processor, performing steps of a game controlling method as described in the above method embodiments, wherein the storage medium may be a volatile or a non-volatile computer-readable storage medium.

The embodiments of the present disclosure further provide a computer program, which, when run by a processor, performs steps of a game controlling method as described in the above method embodiments.

The embodiments of the present disclosure further provide a computer program product, which carries program codes, instructions included in the program codes being used for performing steps of a game controlling method as described in the above method embodiments. For details, reference may be made to the above method embodiments, which is not detailed here.

The computer program product may be implemented as hardware, software or a combination thereof. In an optional embodiment, the computer program product is embodied as a computer storage medium. In a further optional embodiment, the computer program product is embodied as a software product, such as a software development kit (SDK), etc.

It is apparent to those skilled in the art that for the convenience and brevity of the description, the above-described specific working process of the system and apparatus may be referred to the corresponding process in the method embodiments, which is not detailed herein. In the several embodiments provided by the present disclosure, it may be understood that the disclosed system, apparatus and method may be implemented in other way. The above-described apparatus embodiments are merely schematic. For example, the division of units is merely a logical function division, and there may have other division mode in practical implementation; for another example, a plurality of units or components may be combined or integrated into another system, or some features may be omitted or not performed. In addition, the mutual coupling, direct coupling or communication connection as shown or discussed may be indirect coupling or communication connection via some communication interfaces, apparatuses or units, may be electrical, mechanical or in other form.

The units illustrated as separate parts may be or not be physically separated, and components shown as units may be or not be physical units, i.e., may be located at the same place or distributed over a plurality of network units. A portion or all of units may be selected for achieving the objective of the solution of the embodiments according to actual needs.

In addition, various functional units in the various embodiments of the present disclosure may be integrated in one processing unit, individual units may separately and physically exist, or two or more units may be integrated in one unit.

The functionality, if implemented as software functional units and sold and used as independent products, may be stored a non-volatile computer-readable storage medium executable to a processor. Based on such an understanding, the essence of the technical solution of the present disclosure or the portion making contribution to the prior art or the portion of the technical solution may be embodied as a software product, which is stored in a storage medium and comprises several instructions for causing a computer device (which may be a personal computer, a server, a network device, etc.) to perform all or part of the steps of the method as described in the various embodiments of the present disclosure. The above-mentioned storage medium comprises: a U disk, a removable hard disk, a read-only memory (ROM), a random access memory (RAM), a magnetic diskette, an optical disc and other various media capable of storing program codes.

Finally, it is noteworthy that the above-described embodiments are merely specific implementations of the present disclosure for illustrating rather than limiting the technical solution of the present disclosure. The protection scope of the present disclosure is not limited to this. Although the present disclosure has been illustrated in detail with reference to the above embodiments, those of ordinary skill in the art should appreciate that any skilled in the art may make modifications to, readily conceive of changes to, or make equivalent replacements of the technical solution disclosed in the above embodiments; all these modifications, changes or replacements do not make the essence of the corresponding technical solution depart from the spirit and scope of the technical solution of the embodiments of the present disclosure but should be covered in the protection scope of the present disclosure. Therefore, the protection scope of the present disclosure should be defined by the claims.

1. A game controlling method, wherein a scene of a game comprises a plurality of game camps, a plurality of virtual objects and a connection relationship among the virtual objects, and the method comprises:
in response to a battleground establishment event being triggered, establishing a game battleground, the game battleground comprising at least one game camp;
in response to an interaction request of interacting with a first target virtual object in the plurality of virtual objects, determining a belonging target battleground according to a game camp of a requester, and determining whether an interaction condition is met according to virtual object occupation information of each game camp in the belonging target battleground and the connection relationship among the virtual objects; and
in response to the interaction condition being met, sending an interaction request success response, the interaction request success response being used for indicating that an interaction operation on the first target virtual object is permitted.

2. The game controlling method according to claim 1, wherein in response to a battleground establishment event being triggered, establishing the game battleground comprises:
in response to a second target virtual object in the plurality of virtual objects being occupied for a first time by a first game camp that does not belong to any game battleground, establishing the game battleground; wherein the game battleground comprises the first game camp.

3. The game controlling method according to claim 2, wherein the method further comprises: in response to a battleground joining event corresponding to joining the game battleground being triggered, controlling a second game camp that triggers the battleground joining event to join the game battleground.

4. The game controlling method according to claim 3, wherein in response to the battleground joining event corresponding to joining the game battleground being triggered, controlling the second game camp that triggers the battleground joining event to join the game battleground comprises:
in response to the battleground joining event corresponding to joining the game battleground being triggered, determining whether a number of game camps included in the game battleground reaches a preset number threshold and determining whether the first game camp agrees with the second game camp to join the game battleground; and
in response to the number of the game camps included in the game battleground not reaching the preset number threshold and the first game camp agreeing with the second game camp to join the game battleground, controlling the second game camp to join the game battleground.

5. The game controlling method according to claim 1, wherein in response to the interaction request of interacting with the first target virtual object in the plurality of virtual objects, determining the belonging target battleground according to the game camp of the requester, and determining whether the interaction condition is met according to the virtual object occupation information of each game camp in the belonging target battleground and the connection relationship among the virtual objects comprises:
in response to the interaction request of interacting with the first target virtual object in the plurality of virtual objects, determining the belonging target battleground according to the game camp of the requester;
in response to the target battleground being successfully determined, determining whether the interaction condition is met according to the virtual object occupation information of each game camp in the target battleground and the connection relationship among the virtual objects; and
in response to the target battleground failing to be determined, determining whether the interaction condition is met according to the virtual object occupation information of the game camp corresponding to the interaction request and the connection relationship among the virtual objects.

6. The game controlling method according to claim 5, wherein in response to the target battleground being successfully determined, determining whether the interaction condition is met according to the virtual object occupation information of each game camp in the target battleground and the connection relationship among the virtual objects comprises:
determining whether the first target virtual object has a direct connection relationship with a virtual object occupied by a game camp in the target battleground according to the virtual object occupation information of each game camp in the target battleground and the connection relationship among the virtual objects; and
in response to YES, determining that the interaction condition is met.

7. The game controlling method according to claim 6, wherein the plurality of virtual objects comprise: a first virtual object located in a first area, and a second virtual object located in a second area; and
determining whether the first target virtual object has the direct connection relationship with the virtual object occupied by the game camp in the target battleground according to the virtual object occupation information of each game camp in the target battleground and the connection relationship among the virtual objects comprises:
determining whether the first target virtual object is located in the first area; and
in response to the first target virtual object being located in the first area, determining whether the first target virtual object has the direct connection relationship with the virtual object occupied by the game camp in the target battleground according to the virtual object occupation information of each game camp in the target battleground and the connection relationship among the virtual objects.

8. The game controlling method according to claim 1, further comprising: in response to a resource allocation event being triggered, determining resource allocation information of each game camp in the game battleground based on the virtual object occupation information of each game camp in the game battleground; and
allocating game resources based on the resource allocation information.

9. The game controlling method according to claim 8, characterized in that the game resources comprise: camp resources allocated to each game camp in the game battleground, and/or, game character resources allocated to game characters in each game camp in the game battleground.

10. The game controlling method according to claim 8, wherein the resource allocation event comprises at least one of:
the current time reaching preset resource settlement time; or
a third target virtual object in the virtual objects being occupied by any game camp.

11. A game controlling method, wherein a scene of a game comprises a plurality of game camps, a plurality of virtual objects and a connection relationship among the virtual objects, each game camp comprises a plurality of virtual characters, and the method comprises:
in response to an interaction request of a target virtual character interacting with a first target virtual object in the plurality of virtual objects being triggered, sending the interaction request to a server; and
in response to an interaction request success response fed back by the server based on the interaction request, enabling an interaction permission of the target virtual character interacting with the first target virtual object; wherein the interaction request success response is determined by the server according to virtual object occupation information of each game camp in a target battleground to which a game camp of the target virtual character belongs, and the connection relationship among the virtual objects.

12. The game controlling method according to claim 11, wherein the interaction request is an attack request of attacking the first target virtual object, and the method further comprises: in response to the attack request succeeding, controlling the target virtual character to enter an attack scene of attacking the first target virtual object.

13. The game controlling method according to claim 11, wherein the method further comprises: obtaining a game resource allocated by the server to the target virtual character;
wherein the game resource is determined by the server based on the virtual object occupation information corresponding to each game camp in the target battleground after a resource allocation event is triggered.

14. A computer device, comprising a processor and a memory, the memory storing machine-readable instructions executable to the processor, the processor being used for executing the machine-readable instructions stored in the memory, the machine-readable instructions, when executed by the processor, causing the processor to:
in response to a battleground establishment event being triggered, establish a game battleground, the game battleground comprising at least one game camp;
in response to an interaction request of interacting with a first target virtual object in a plurality of virtual objects, determine a belonging target battleground according to a game camp of a requester, and determine whether an interaction condition is met according to virtual object occupation information of each game camp in the belonging target battleground and a connection relationship among the virtual objects; and
in response to the interaction condition being met, send an interaction request success response, the interaction request success response being used for indicating that an interaction operation on the first target virtual object is permitted,
wherein a scene of a game comprises a plurality of game camps, the plurality of virtual objects and the connection relationship among the virtual objects.

15. The device according to claim 14, wherein the instructions to, in response to a battleground establishment event being triggered, establish the game battleground comprises instructions causing the processor to:
in response to a second target virtual object in the plurality of virtual objects being occupied for a first time by a first game camp that does not belong to any game battleground, establish the game battleground; wherein the game battleground comprises the first game camp.

16. The device according to claim 15, wherein the memory further comprises instructions to cause the processor to: in response to a battleground joining event corresponding to joining the game battleground being triggered, control a second game camp that triggers the battleground joining event to join the game battleground.

17. The device according to claim 16, wherein the instructions to, in response to the battleground joining event corresponding to joining the game battleground being triggered, control the second game camp that triggers the battleground joining event to join the game battleground comprises instructions to cause the processor to:
in response to the battleground joining event corresponding to joining the game battleground being triggered, determine whether a number of game camps included in the game battleground reaches a preset number threshold and determining whether the first game camp agrees with the second game camp to join the game battleground; and
in response to the number of the game camps included in the game battleground not reaching the preset number threshold and the first game camp agreeing with the second game camp to join the game battleground, control the second game camp to join the game battleground.

18. The device according to claim 14, wherein the instructions to, in response to the interaction request of interacting with the first target virtual object in the plurality of virtual objects, determine the belonging target battleground according to the game camp of the requester, and determine whether the interaction condition is met according to the virtual object occupation information of each game camp in the belonging target battleground and the connection relationship among the virtual objects comprises instructions to cause the processor to:
in response to the interaction request of interacting with the first target virtual object in the plurality of virtual objects, determine the belonging target battleground according to the game camp of the requester;
in response to the target battleground being successfully determined, determine whether the interaction condition is met according to the virtual object occupation information of each game camp in the target battleground and the connection relationship among the virtual objects; and
in response to the target battleground failing to be determined, determine whether the interaction condition is met according to the virtual object occupation information of the game camp corresponding to the interaction request and the connection relationship among the virtual objects.

19. The device according to claim 18, wherein the instructions to, in response to the target battleground being successfully determined, determine whether the interaction condition is met according to the virtual object occupation information of each game camp in the target battleground and the connection relationship among the virtual objects comprises instructions to cause the processor to:
determine whether the first target virtual object has a direct connection relationship with a virtual object occupied by a game camp in the target battleground according to the virtual object occupation information of each game camp in the target battleground and the connection relationship among the virtual objects; and
in response to YES, determine that the interaction condition is met.

20. The device according to claim 19, wherein the plurality of virtual objects comprise: a first virtual object located in a first area, and a second virtual object located in a second area; and
the instructions to determine whether the first target virtual object has the direct connection relationship with the virtual object occupied by the game camp in the target battleground according to the virtual object occupation information of each game camp in the target battleground and the connection relationship among the virtual objects comprises instructions to cause the processor to:
determine whether the first target virtual object is located in the first area; and
in response to the first target virtual object being located in the first area, determine whether the first target virtual object has the direct connection relationship with the virtual object occupied by the game camp in the target battleground according to the virtual object occupation information of each game camp in the target battleground and the connection relationship among the virtual objects.
